(19) United States
(12) Patent Application Publication
(10) Pub. No.: US 2025/0323315 A1
(43) Pub. Date: Oct. 16, 2025

(54) INORGANIC SOLID ELECTROLYTES AND EFFICIENT METHODS FOR MAKING THE SAME

(71) Applicant: Florida State University Research Foundation, Inc., Tallahassee, FL (US)

(72) Inventors: Yan-Yan Hu, Tallahassee, FL (US); Bright Ogbolu, Tallahassee, FL (US); Thilina Nadeemali Dikella Dikella Gamaralalage, Tallahassee, FL (US)

(21) Appl. No.: 19/176,492

(22) Filed: Apr. 11, 2025

Related U.S. Application Data
(60) Provisional application No. 63/632,720, filed on Apr. 11, 2024.

(51) Int. Cl. H01M 10/0562; C01B 33/08; G01N 27/333; H01M 10/052

(52) U.S. Cl. CPC H01M 10/0562; C01B 33/08; G01N 27/333; H01M 10/052; C01P 2002/72; C01P 2002/82; C01P 2002/86; C01P 2004/03; C01P 2006/40; H01M 2300/008

(57) ABSTRACT

In accordance with the purpose(s) of the present disclosure, as embodied and broadly described herein, the disclosure, in one aspect, relates to inorganic solid electrolytes and synthesis of inorganic solid electrolytes. The electrolytes have the general formula A_{z}NᵥS_{1-y}O_{y}X₅, exhibit superionic conductivity, and can be produced via a relatively fast synthesis route. The electrolytes can be a component of different types of batteries.

### CROSS-REFERENCE TO RELATED APPLICATIONS

This application claims the benefit of and priority to co-pending U.S. Provisional Patent Application No. 63/632,720, filed on Apr. 11, 2024, the contents of which are incorporated by reference herein in their entireties.

### BACKGROUND

The burgeoning interest towards sustainable and renewable energy has engendered a need to develop fast-ion conducting solid electrolytes to cater for the ever-increasing demand for high-performance electrochemical energy storage devices, such as smart battery systems and all-solid-state batteries. Organic electrolyte-based commercial batteries that currently dominate the global market suffer from several limitations closely linked with safety issues, therefore, solid state electrolytes with improved mechanical and chemical stability, high energy density, wide electrochemical window, and electrochemical stability have been poised as the next-generation energy storage material. Examples of inorganic solid electrolytes include sulfides, oxides, and halides. Each class exhibits beneficial properties. Sulfide electrolytes, for example, have high ion conduction properties. However, sulfide, oxide, and halide solid electrolytes also suffer from drawbacks that hinder their commercialization. There is, therefore, a need for inorganic solid electrolytes that exhibit good mechanical and electrochemical properties with fewer drawbacks.

### SUMMARY

In accordance with the purpose(s) of the present disclosure, as embodied and broadly described herein, the disclosure, in one aspect, relates to inorganic solid electrolytes and synthesis of inorganic solid electrolytes. The electrolytes have the general formula A_{z}NᵥS_{1-y}O_{y}X₅, exhibit superionic conductivity, and can be produced via a relatively fast synthesis route. The electrolytes can be a component of different types of batteries.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a representative Nyquist plot and corresponding equivalent circuit fitting of Li₂TaS_{0.1}O_{0.9}Cl₅ (LTSOC) and Li₂TaSCl₅ (LTSC) at 25° C.

FIG. 1B shows a representative Nyquist plot and corresponding equivalent circuit fitting of LTSOC at −20° C.

FIG. 1C shows variable-temperature Nyquist plots obtained for LTSOC.

FIG. 1D shows an Arrhenius-type plot of LTSOC.

FIG. 2A shows results of DC-Polarization on a symmetric SS|LTSOC|SS cell (SS: stainless steel) for determination of σₑₗ.

FIG. 2B shows the respective I-V curves of the LTSOC under different DC voltages with the linear fit. The electric resistances were calculated based on Ohm's law. Taking the sample's geometric dimensions into account, the conductivity values were calculated.

FIG. 3 shows lab X-ray diffraction of highly disordered Li₂TaS_{0.1}O_{0.9}Cl₅ and Li₂TaSCl₅.

FIGS. 4A-4B show the average and local structural data for Li₂TaA₁₋ₓOxCl₅ series. (a) Powder XRD patterns (b) ⁶Li MAS NMR for Li₂TaSCl₅ and Li₂TaS_{0.1}O_{0.9}Cl₅.

FIGS. 5A-5F show Raman Spectra of LTSOC compared with related structure and local structural illustration.

FIG. 6 shows scanning electron microscope (SEM) and energy dispersive spectroscopy (EDS) mapping of as milled Li₂TaS_{0.1}O_{0.9}Cl₅.

FIGS. 7A-7B show lithium-ion dynamics of the Li₂TaS₁₋ₓOₓCl₅ series from ⁷Li NMR spin-lattice relaxation (T₁) measurements showing (a) RT T₁ changes with increasing oxygen content in Li₂TaS₁₋ₓOₓCl₅ (b) VT T1 plots.

FIGS. 8A-8B show the electrochemical properties of Li₂TaS₁₋ₓOₓCl₅ Arrhenius plots of the Li₂TaS₁₋ₓOₓCl₅ series measured from −20° C. to 60° C. (A Comparison of the ionic conductivities and activation energies trend in the Li₂TaS₁₋ₓOₓCl₅ series (B).

FIGS. 9A-9B show all-solid-state battery cycling performance of Li₂TaS_{0.1}O_{0.9}Cl₅ (a) Rate capability plots (b) Voltage-capacity profiles showing the charge-discharge curves at 0.05, 0.1, 0.2, 0.5 and 1C.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an excipient” include, but are not limited to, mixtures or combinations of two or more such excipients, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. Thus, for example, if a component is in an amount of about 1%, 2%, 3%, 4%, or 5%, where any value can be a lower and upper endpoint of a range, then any range is contemplated between 1% and 5% (e.g., 1% to 3%, 2% to 4%, etc.).

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated +10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Inorganic Solid Electrolytes and Methods of Making and Using the Same

The present disclosure provides for inorganic solid electrolytes and the method of making and using inorganic solid electrolytes. The electrolytes have the general formula A_{z}NᵥS_{1-y}O_{y}X₅, and exhibit superionic properties, even at low temperatures. With high ionic conductivity at low temperatures, the electrolytes have the potential to provide steady performance for electronic devices, such as electric vehicles, in cold environments. The electrolytes can be a component of different types of batteries, such as solid-state batteries. A relatively simple and fast synthesis route makes the production of the electrolytes efficient and feasible for scale-up.

In one aspect, the electrolytes or compounds disclosed herein have the formula A_{z}NᵥS_{1-y}O_{y}X₅, where A is Li, Na, K, or any combination thereof; N is Ta, Nb, or any combination thereof; X is Cl, Br, I, or any combination thereof; z is greater than zero to about 2; y is greater than or equal to zero to less than 1; and the sum (z+5v) is equal to 7. In another aspect, the electrolytes or compounds can also have the formula Li₂TaS_{1-y}O_{y}Cl₅. In another aspect, z can be from 0.01 to about 2.0, or about 0.01, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0, where any value can be a lower and upper endpoint of a range (e.g., 1.0 to 2.0). In another aspect, v can be from about 0.01 to about 1.5, or about 0.01, 0.05, 0.1, 0.2, 0.3, 0.4, 0.5, 0.6, 0.7, 0.8, 0.9, 1.0, 1.1, 1.2, 1.3, 1.4, 1.5, where any value can be a lower and upper endpoint of a range (e.g., 0.5 to 1.2). For any formula of electrolyte or compound disclosed herein, y can be from about 0.01 to about 0.99, or about 0.01, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, or 0.99, where any value can be a lower and upper endpoint of a range (e.g., 0.10 to 0.90). In a further aspect, the electrolyte or compound is Li₂TaS_{0.1}O_{0.9}Cl₅, Li₂TaS_{0.4}O_{0.6}Cl₅, or Li₂TaS_{0.7}O_{0.3}Cl₅.

The electrolytes disclosed herein have several desirable properties. In one aspect, the electrolytes can have good ionic conductivity. The electrolytes can have an ionic conductivity of at least about 1.00 mS/cm, at least about 2.00 mS/cm, at least about 2.50 mS/cm, at least about 3.00 mS/cm, or at least about 3.50 mS/cm. In another aspect, the ionic conductivity of the electrolytes can be from about 1.00 mS/cm to about 10.00 mS/cm, or about 1.00 mS/cm, 2.00 mS/cm, 3.00 mS/cm, 4.00 mS/cm, 5.00 mS/cm, 6.00 mS/cm, 7.00 mS/cm, 8.00 mS/cm, 9.00 mS/cm, or 10.00 mS/cm, where any value can be a lower and upper endpoint of a range (e.g., 2.00 mS/cm to 5.00 mS/cm). In a further aspect, the electrolytes ionic conductivity can be measured at about room temperature, about 18° C. to about 24° C., or about 20° C. to about 22° C. The electrolytes can be characterized as having superionic conductivity, which refers to ionic conductivity values that are greater than 1 mS/cm. In one aspect, the electrolytes remain conductive over a temperature range of about 0° C. to about 100° C., or about 0° C., 10° C., 20° C., 30° C., 40° C., 50° C., 60° C., 70° C., 80° C., 90° C., or 100° C., where any value can be a lower and upper endpoint of a range (e.g., 0° C. to 80° C.). In another aspect, the electrolytes exhibit superionic conductivity over the same temperature ranges. Exemplary methods for determining ionic conductivity are provided in the Examples.

In one aspect, the electrolytes disclosed herein can have low electronic conductivities. In one aspect, the electrolytes disclosed herein can have an electronic conductivity of less than about 1.00×108 S/cm, less than about 5.00×10⁻⁹ S/cm, or less than about 2.00×10⁻⁹ S/cm. In another aspect, the electrolytes can have an electronic conductivity of from about 1.00×10⁻⁷ S/cm to about 1.00×10⁻¹⁰ S/cm, or about 1.00×10⁻⁷ S/cm, 5.00×10⁻⁸ S/cm, 1.00×10⁻⁸ S/cm, 5.00×10⁻⁹ S/cm, 1.00×10⁻⁹ S/cm, 5.00×10⁻¹⁰ S/cm, or 1.00×10⁻¹⁰ S/cm, where any value can be a lower and upper endpoint of a range (e.g., 1.00×10⁻⁸ S/cm to 1.00×10⁻¹⁰ S/cm). Exemplary methods for determining electronic conductivity are provided in the Examples.

In another aspect, the electrolytes disclosed herein can have relatively low activation energy barriers to ion transport. In one aspect, the electrolytes can have an activation energy of from about 0.1 eV to about 0.5 eV, or about 0.1 eV, 0.2 eV, 0.3 eV, 0.4 eV, or 0.5 eV, where any value can be a lower and upper endpoint of a range (e.g., 0.2 eV to 0.3 eV).

In one aspect, the electrolytes or compounds disclosed herein are disordered with a glassy or amorphous structure.

Additionally, the electrolytes described herein possess unique solid-state NMR spectra. In one aspect, the Li-containing electrolytes can have peaks at about −1.1 ppm, −0.68 ppm, and 2.8 ppm, and −1.1 ppm, and 2.8 ppm as determined by ⁶Li solid-state NMR spectroscopy. Exemplary methods for performing NMR measurements are provided in the Examples.

Also disclosed is a method for making sulfide electrolytes having the formula A_{z}NᵥS_{1-y}O_{y}X₅, where A is Li, Na, K, or any combination thereof; N is Ta, Nb, or any combination thereof; X is Cl, Br, I, or any combination thereof; z is greater than zero to about 2; y is greater than or equal to zero to less than 1; and the sum (z+5v) is equal to 7. The method includes combining a plurality of precursor compounds, such as salts, in various amounts in the solid state and mixing them together by mechanochemical milling. In one aspect, the precursor compounds are mixed together in stoichiometric amounts. The precursor compounds mixed together can include A₂S, A₂O, NX₅, and any combination thereof, to produce a precursor mixture. In a further aspect, the precursor compounds mixed together can include A₂S, selected from the group consisting of Li₂S, Na₂S, K₂S, and any combination thereof; A₂O, selected from the group consisting of Li₂O, Na₂O, K₂O, and any combination thereof; and NX₅, selected from the group consisting of TaCl₅, TaBr₅, Tal₅, NbCl₅, NbBr₅, Nbl₅, and any combination thereof. The components of the precursor mixture can be hand-ground before mechanochemical milling to form a homogenous precursor mixture. In another aspect, forming the precursor mixture and/or forming the homogenous precursor mixture can be performed in an inert atmosphere, such as an argon or nitrogen atmosphere, with an O₂ content of less than 20 ppm, less than 10 ppm, less than 1 ppm, less than 0.5 ppm, or less than 0.1 ppm.

The precursor compounds used to produce the electrolytes described herein are generally highly pure materials. In one aspect, each of the precursor compounds has a purity of greater than 99%, greater than 99.5%, or greater than 99.9%. In one aspect, each precursor compound used to produce the electrolytes are substantially anhydrous, where each precursor compound is at least 95% moisture free, at least 98% moisture free, at least 99% moisture free, at least 99.9% moisture free, or 100% moisture free. In another aspect, each precursor compound has less than 0.5 ppm water, less than 0.25 ppm water, or less than 0.1 ppm water.

The precursor compounds can be mixed by mechanochemical milling. Mixing of the precursor compounds can occur in a mixing jar or container using one or more balls to produce a complex motion that combines back-and-forth swings with short lateral movements. In one aspect, the precursor compounds are mixed with one another for less than seven hours, less than 5 hours, or less than 3 hours. In another aspect, the compounds are mixed from about 1 hour to about 5 hours or about 1 hour, 2 hours, 3 hours, 4 hours, or 5 hours, where any value can be a lower and upper endpoint of a range (e.g., 1 hour to 4 hours). In one aspect, the precursor compounds are mixed in an inert atmosphere such as, for example, nitrogen or argon. In one aspect,, the inert atmosphere has less than 20 ppm oxygen, less than 10 ppm oxygen, less than 1 ppm oxygen, less than 0.5 ppm oxygen, less than 0.25 ppm oxygen, or less than 0.1 ppm oxygen. In some aspects, the mixture is further dried after mixing. After mixing, the mixture can be pelletized. The pellets can be formed by pressing the mechanochemically milled mixture into a mold.

The compounds disclosed herein can be components of different types of batteries, such as solid-state batteries. The component of the battery including the compounds can be an electrolyte, a separator membrane, or a combination thereof. The compounds disclosed herein can also be components of different types of sensors, such as ion-selective electrodes, that are configured for ion detection (e.g., Li⁺ detection). Sensors can be used to measure or detect metal contamination in water sources or biofluids.

### Aspects

Aspect 1. A compound having the formula A_{z}NᵥS_{1-y}O_{y}X₅, wherein A is Li, Na, K, or any combination thereof; N is Ta, Nb, or any combination thereof; X is Cl, Br, I, or any combination thereof; z is greater than zero to about 2; y is greater than or equal to zero to less than 1; and the sum (z+5v) is equal to 7.

Aspect 2. The compound of aspect 1, wherein A is Li.

Aspect 3. The compound of aspect 1, wherein A is Na.

Aspect 4. The compound of any one of aspects 1-3, wherein z is about 1.0 to about 2.0.

Aspect 5. The compound of any one of aspects 1-4, wherein N is Ta.

Aspect 6. The compound of any one of aspects 1-5, wherein v is about 1.00 to about 1.50.

Aspect 7. The compound of any one of aspects 1-6, wherein y is from about 0.01 to about 0.99.

Aspect 8. The compound of any one of aspects 1-6, wherein y is from about 0.10 to about 0.90.

Aspect 9. The compound of any one of aspects 1-8, wherein X is Cl.

Aspect 10. The compound of any one of aspects 1-8, wherein X is Br.

Aspect 11. The compound of aspect 1, wherein the compound is Li₂TaS_{1-y}O_{y}Cl₅.

Aspect 12. The compound of aspect 11, wherein y is from about 0.10 to about 0.99.

Aspect 13. The compound of aspect 11, wherein y is greater than 0.8 to less than 1.0.

Aspect 14. The compound of aspect 1, wherein the compound is Li₂TaS_{0.1}O_{0.9}Cl₅, Li₂TaS_{0.4}O_{0.6}Cl₅, or Li₂TaS_{0.7}O_{0.3}Cl₅.

Aspect 15. The compound of any one of aspects 1-14, wherein the compound has an ionic conductivity of at least about 1.00 mS/cm.

Aspect 16. The compound of any one of aspects 1-15, wherein the compound has an ionic conductivity of at least about 1.00 mS/cm to about 10.00 mS/cm.

Aspect 17. The compound of any one of aspects 1-16, wherein the compound has an electronic conductivity of less than 1.00×10⁻⁸ S/cm.

Aspect 18. The compound of any one of aspects 1-17, wherein the compound has an electronic conductivity of about 1.00×10⁻⁸ S/cm to about 1.00×10⁻¹⁰ S/cm.

Aspect 19. The compound of any one of aspects 1-18, wherein the compound is conductive over a temperature range of about 0° C. to about 100° C.

Aspect 20. The compound of any one of aspects 1-18, wherein the compound exhibits superionic conductivity over a temperature range of about 0° C. to about 80° C.

Aspect 21. The compound of any one of aspects 1-20, wherein the compound has an activation energy for ion transport of from about 0.1 eV to about 0.5 eV.

Aspect 22. The compound of any one of aspects 1-20, wherein the compound has an activation energy for ion transport of from about 0.2 eV to about 0.3 eV.

Aspect 23. The compound of any one of aspects 1-22, wherein the compound is amorphous.

Aspect 24. The compound of any one of aspects 1-23, wherein the compound has peaks at about −1.1 ppm, −0.68 ppm, and 2.8 ppm as determined by Li solid-state NMR spectroscopy.

Aspect 25. A method for making a compound having the formula A_{z}NᵥS_{1-y}O_{y}X₅, wherein A is Li, Na, K, or any combination thereof; N is Ta, Nb, or any combination thereof; X is Cl, Br, I, or any combination thereof; z is greater than zero to about 2; y is greater than or equal to zero to less than 1; and the sum (z+5v) is equal to 7; the method comprising (a) combining in the solid state the following components (i) A₂S, selected from the group consisting of Li₂S, Na₂S, K₂S, and any combination thereof; (ii) A₂O, selected from the group consisting of Li₂O, Na₂O, K₂O, and any combination thereof; and (iii) NX₅, selected from the group consisting of TaCl₅, TaBr₅, Tal₅, NbCl₅, NbBr₅, Nbl₅, and any combination thereof, to produce a precursor mixture; and (b) mixing the precursor mixture by mechanochemical milling.

Aspect 26. The method of aspect 25, wherein precursor mixture is mixed by mechanochemical milling for about 1 hour to about 4 hours.

Aspect 27. The method of aspect 25, wherein precursor mixture is mixed by mechanochemical milling for about 2 hours.

Aspect 28. The method of any one of aspects 25-27, wherein the components are substantially anhydrous.

Aspect 29. The method of any one of aspects 25-28, wherein the components are mixed in an inert atmosphere.

Aspect 30. The method of any one of aspects 25-29, wherein the components are combined in stoichiometric amounts.

Aspect 31. A compound produced by the method of any one of aspects 25-30.

Aspect 32. A battery comprising the compound in any one of aspects 1-24 and 31.

Aspect 33. The battery of aspect 32, wherein the battery is a solid-state battery.

Aspect 34. A battery comprising the compound in any one of aspects 1-24 and 31.

Aspect 35. A sensor for ion detection, comprising the compound in any one of aspects 1-24 and 31.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### Materials and Methods

### Synthesis

Lithium sulfide (99.9% Alfa Aesar), lithium oxide (99.5% Alfa Aesar), and tantalum chloride (99.99% Sigma Aldrich) were stored in an argon-filled glovebox, with moisture and O₂ contents of <0.1 ppm each, to avoid moisture and ambient environment. A stoichiometric amount of the precursors was hand-ground and transferred into a 20-mL zirconia milling jar, with three 10 mm-sized zirconia balls, and vacuum sealed within the argon-filled glovebox. Mechanochemical milling was done using the 8000M Mixer/Mill® High-Energy Ball Mill for 2 hours. The mechanically homogenized sample was stored in a glass vial inside the argon-filled glovebox (MBroun) for further characterization.

### Characterization

Powder X-ray Diffraction—The prepared sample was sealed on a zero-background sample holder with Kapton film. The sample was analyzed in a Rigaku SmartLab X-ray diffractometer with a Cu source (wavelength of 0.154 nm). A step size of 0.03° and a scan rate of 2°/min were used to collect the diffraction data for the 10° to 70° range of 2θ values.

Electrochemical Impedance Spectroscopy (EIS)—For impedance measurements, the sample was hand-ground and pressed in a 10 mm diameter mold to make a ˜0.8 mm thick pellet. The pellet was assembled in a split cell with steel as the blocking electrode. The measurement of potentiostatic EIS was carried out using a Gamry electrochemical analyzer and conductivities were calculated from the resulting Nyquist plots. Variable temperature EIS characterization was performed from −20° C. to 100° C. to calculate the activation energy via Arrhenius plots.

### Results and Discussion

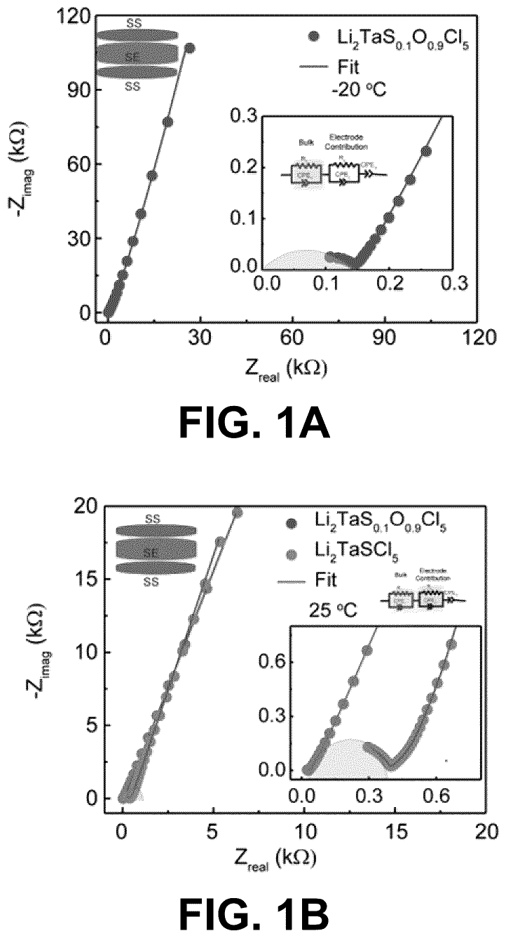

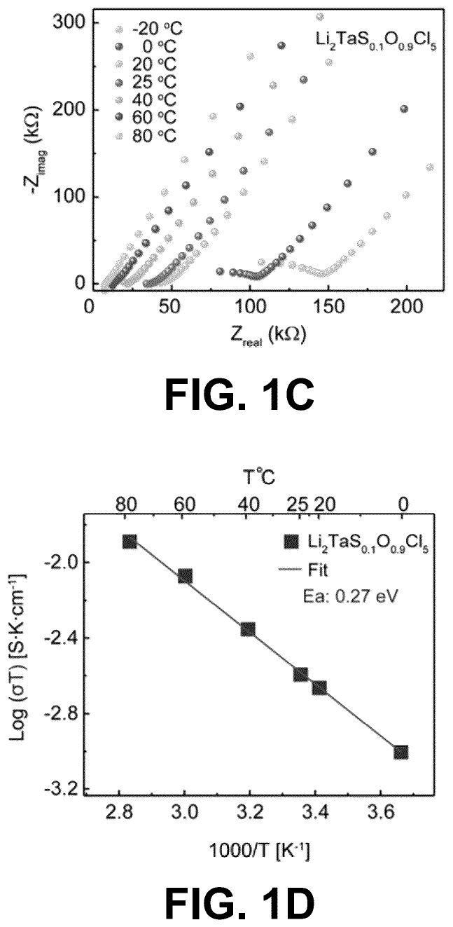

FIG. 1A shows the Nyquist plots of impedance values from EIS measurements. A bulk impedance of ˜400 ohms was observed for the pristine material Li₂TaSCl₅. This translates into an ionic conductivity value of ˜0.25 mS/cm. Upon substitution of the S²⁻ with O²⁻ a significant drop in the impedance values resulted.

Li₂TaS_{0.1}O_{0.9}Cl₅ (LTSOC) displays an ionic conductivity of 3.69 mS/cm, an order-of-magnitude enhancement compared with Li₂TaSCl₅ (LTSC). This value is one of the highest ionic conductivities achieved so far in this class of oxo-sulfide SEs. The impedance spectra of LTSOC are composed of a single suppressed semicircle at high frequency and a sloped line at low frequency. The data has been modeled with the two (RQ)+Q equivalent circuit model to quantitatively understand these processes and their contributions to the impedance in LTSOC. A resistor (R) connected in parallel to a constant phase element (Q) is represented by the symbol (RQ). To account for heterogeneous surfaces between the steel electrode contacts and the pellet, a constant phase element was employed instead of a capacitor. The low-frequency tail is in line with capacitive build-up at steel-blocking electrodes. The high-frequency (RQ) semicircle can be attributed to a combination of bulk and grain-boundary impedances, as in other Li-ion conducting halide SEs. The incomplete (RQ) semicircle, which implies several overlapping processes at high frequencies, provides evidence for this. To differentiate between the contributions of the bulk (Rb) and grain-boundary (R_{gb}) to the total resistivity (Rₜ), a low temperature of −20° C., FIG. 1B, was selected rather than RT. The capacitance values extracted from the equivalent circuit fitting for LTSOC is 2.68×10⁻¹¹ F. Even at very low temperatures, such as −20° C., bulk and grain boundary contributions cannot be reasonably deconvoluted. Therefore, the conductivities described here indicate total conductivities. A capacitance value of 5.26×10⁻⁶ F was extracted for the mid-frequency semicircle, which implies it's due to the electrode contribution.¹¹⁻¹³

Variable-temperature EIS experiments were conducted, as shown in FIG. 1C, to determine the material behavior at a wide temperature window and to determine the activation energy using the Arrhenius relationship. Notably, superionic Li conductivity (>1 mS/cm) was observed even at temperatures as low as 0° C. This is a game changer as it can potentially provide steady performance in harsh environments, such as cold climates, for electronic devices and electric vehicles.

A relatively low activation energy value of ˜0.27 eV was computed from the slope of the Arrhenius plot shown in FIG. 1D. This value falls within the range of that commonly reported for halide and sulfide fast-ion conductors 14 A linear relationship of the conductivity values versus temperature suggests that no phase change is occurring in the range of temperatures tested, 0-80° C. This hints at a thermally stable electrolyte.

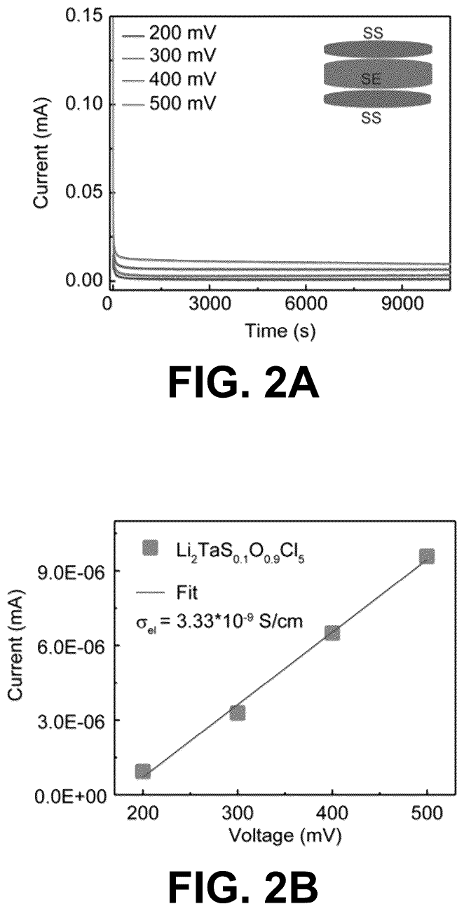

For the experimental investigation of electronic contribution (σₑₗ) to the total conductivity, the DC polarization technique was applied to the samples in a symmetric setup SS|LTSOC|SS. FIG. 2A shows results of DC-Polarization on a symmetric SS|LTSOC|SS cell (SS: stainless steel) for determination of σₑₗ. Equilibrium currents were monitored at different voltages to increase the accuracy of DC polarization measurements. Then, using Ohm's rule (V=IR), the respective partial conductivities can be determined from the voltage vs. current plot. ¹⁵ Li₂TaS_{0.1}O_{0.9}Cl₅ exhibits a low electronic conductivity of ˜3.33×10⁻⁹ S/cm (FIG. 2B), which ensures a negligible contribution of electron transport to the measured total conductivity.

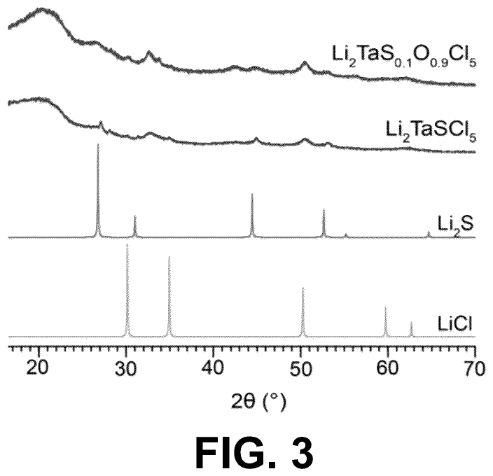

The XRD data in FIG. 3 shows no crystalline reflections for LTSC and LTSOC. This suggests that the material is amorphous with no long-range order, typical of glasses. This has an advantage for catholyte fabrication, as it improves the interfacial contact between the SEs and cathode active materials, and increased disorder facilitates faster Li-ion motion. A comprehensive local structure and ion dynamics study using advanced solid-state NMR techniques is ongoing.

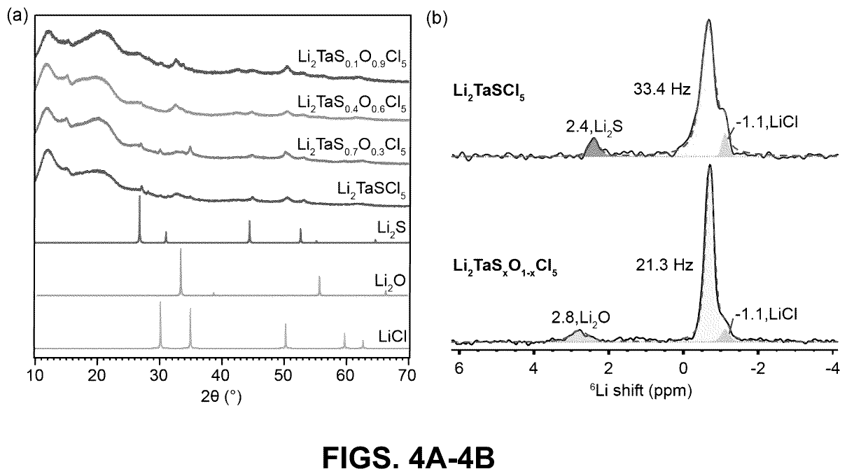

Additional compounds described herein were further evaluated. To understand the structural properties of the Li₂TaS₁₋ₓOₓCl₅ samples prepared via rapid 2-Hr BM synthesis, XRD and high-resolution NMR were conducted. The powder XRD patterns for the Li₂TaS_{0.1}O_{0.9}Cl₅ series, FIG. 4A, exhibit broad diffraction peaks, characteristic of amorphous materials. This broadening indicates a lack of long-range order in the crystal structure, suggesting that the material does not form well-defined crystalline phases.

The deconvoluted NMR plots in FIG. 4B reveal the local structural environments in both LTSC and LTSOC. The isotropic peaks in both spectra resonate at approximately −0.64 and −0.67 ppm respectively, indicating nearly identical chemical environments for the observed nuclei. However, a significant difference is observed in the spectra widths. The linewidth for LTSC is about 34 Hz, which is more than 1.5 times broader than the 21 Hz linewidth of LTSOC. This broader linewidth in LTSC suggests a greater degree of local structural disorder with restricted ion dynamics compared to LTSOC.⁺ In contrast, the narrower linewidth in LTSOC indicates that the lithium ions are in a more homogenous local environment, which could be linked to its enhanced ionic transport properties, as fewer interactions and less disorder can facilitate easier ion movement.⁺ Both NMR and PXRD data revealed the presence of small amounts of LiCl, and Li₂S impurities in LTSC and LiCl and Li₂O impurities in LTSOC. The presence of LiCl phase suggests a multistep reaction of the precursors to the final product, of which the intermediate phase generates LiCl.

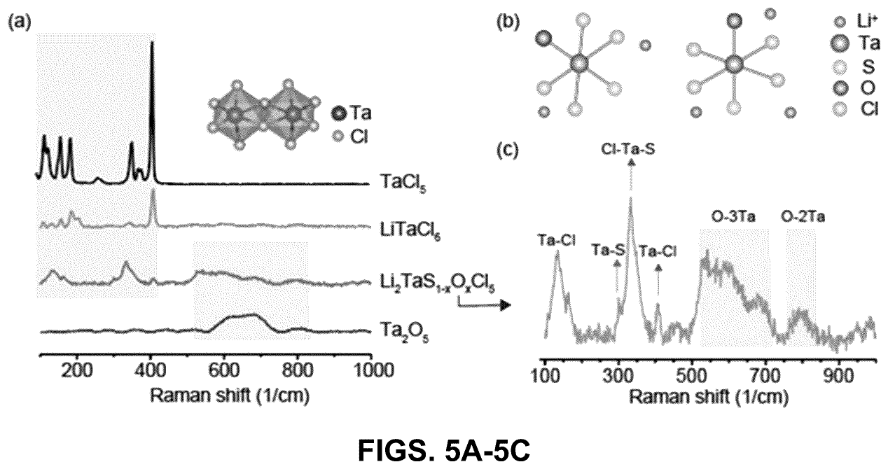

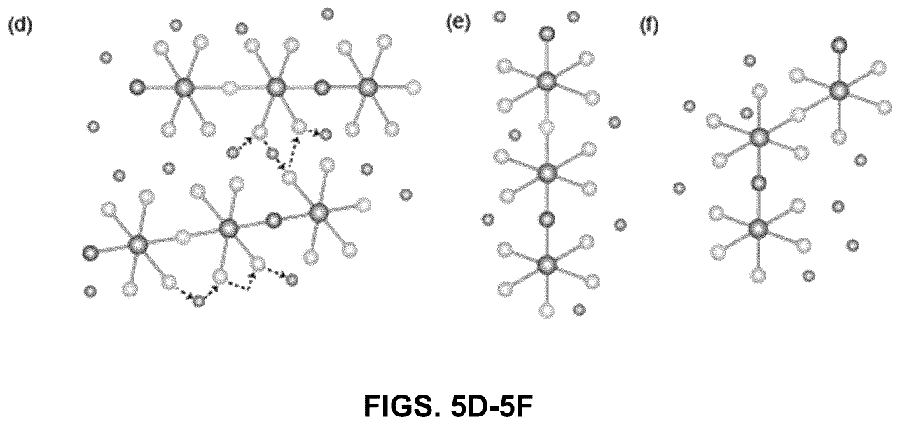

The Raman spectra presented in FIG. 5A compares different tantalum-based compounds, namely TaCl₅, LiTaCl6, Li₂TaS₁₋ₓOₓCl₅, and Ta₂O₅. The black spectrum of TaCl₅ exhibits strong characteristic peaks, particularly in the 200-500 cm⁻¹ region, which are attributed to Ta—Cl vibrational modes. As Li is introduced in LiTaCl₆ (green spectrum), peak intensity decreases, and there are slight spectral shifts, indicating modifications in the local structure around Ta atoms. The Li₂TaS₁₋ₓOₓCl₅ spectrum (red curve) displays further peak broadening and shifts, suggesting significant structural alterations due to the partial substitution of sulfur (S) and oxygen (O) for chlorine (Cl) in the anionic framework.

FIG. 5C provides a detailed look at the Raman peaks and their assignments. The low-wavenumber peaks (˜200-400 cm⁻¹) correspond to Ta—Cl and Ta—S vibrations, indicating the presence of mixed halide and chalcogenide coordination. A peak near 500 cm⁻¹ is labeled as a Cl—Ta—S vibrational mode, suggesting a direct interaction between chloride and sulfide ligands in the Ta-centered octahedra. The higher-wavenumber region (600-900 cm⁻¹, highlighted in blue) features broad Raman bands associated with oxygen incorporation, specifically linked to O-3Ta and O-2Ta stretching modes. These peaks confirm the presence of Ta—O bonds, reinforcing the notion of partial oxidation in the material. The spectral broadening in this region also suggests a degree of structural disorder, which could impact the material's ionic transport properties.

The coordination environments of tantalum in these materials are illustrated in FIG. 5B, showing Ta-centered octahedral units with varying ligand compositions. In LiTaCl₆, tantalum is predominantly coordinated by chlorine (Cl), forming an ordered TaCl₆ octahedral structure. However, in Li₂TaS₁₋ₓOₓCl₅, the replacement of some chloride ligands with sulfur (S) and oxygen (O) alters the Ta coordination geometry. This mixed-anion environment can impact the material's ionic conductivity and electrochemical stability, particularly if anion disorder facilitates Li-ion migration pathways.

FIGS. 5D-5F provide further insights into the crystal structures. FIG. 5D likely represents Li₂TaS₁₋ₓOₓCl₅, showing a distorted framework where S, O, and Cl ligands interact in a complex coordination environment. The dashed lines represent potential Li⁺ migration pathways, which play a crucial role in ionic conductivity. The weak interaction between Li⁺ ions and anions, primarily Cl⁻, reduces energy barriers for migration, facilitating efficient Li+transport. FIG. 5E illustrates a possible structural arrangement in which the Ta-centered octahedra forms a linked, polymer-like chain, maintaining a symmetrical configuration of anion clusters. In contrast, FIG. 5F depicts a slightly distorted or branched arrangement, suggesting structural flexibility that could further influence ionic mobility and conductivity.

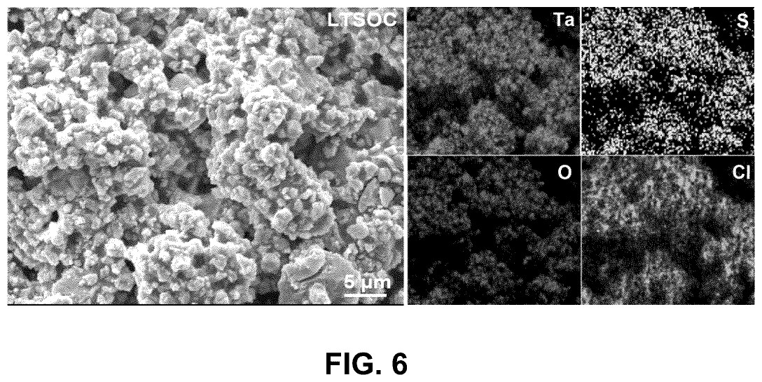

SEM and EDS images were obtained for ball-milled LTSOC powders to examine sample morphology (FIG. 6). The images reveal that LTSOC particles tend to aggregate. This aggregation likely enhances contact, reduces grain boundaries, and improves transport properties. The corresponding EDS images show a uniform distribution of the constituent elements—Ta, S, O, and Cl—in the LTSOC sample.

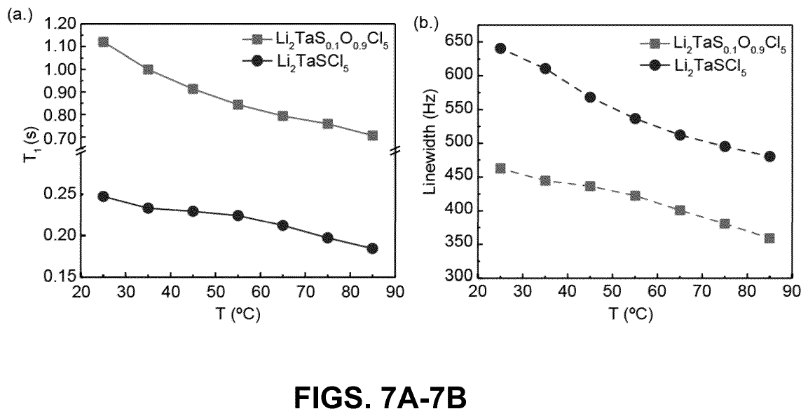

FIG. 7A shows that variable temperature ⁷Li T₁ spin-lattice relaxation times is higher with oxygen incorporation, At room temperature, LTSOC reaches ˜1.1 s and LTSC around 0.25 s. This suggests faster Li-ion relaxation in LTSC compared to LTSOC, likely due to stronger Li⁺—O interactions from the more electronegative oxygen anions. The relaxation behavior of both LTSC and LTSOC falls within the intermediate-motion region described by the Bloembergen-Purcell-Pound theory. A decrease in peak width with increased temperature is expected, as shown in FIG. 7B.

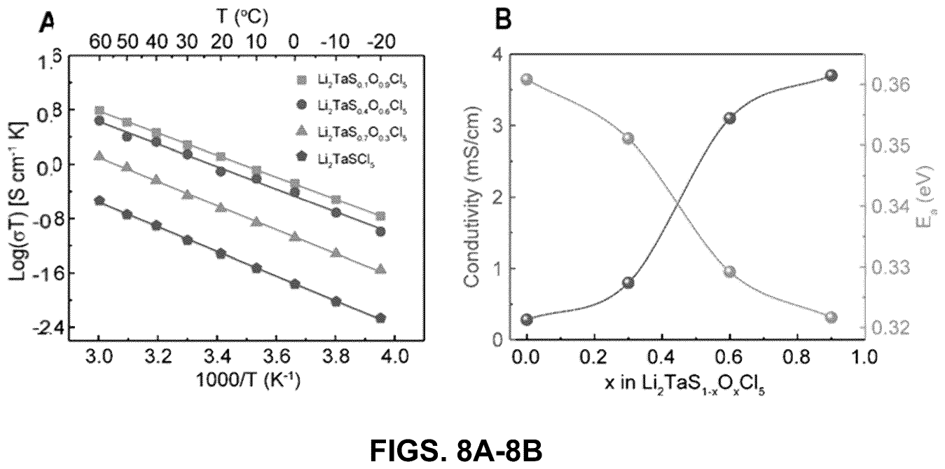

FIG. 8A displays Arrhenius plots obtained from variable temperature EIS measurements for the Li₂TaS₁₋ₓOₓCl₅ series, the extracted activation energy and RT ionic conductivities are depicted in FIG. 8B. For the unsubstituted LTSC, a relatively higher activation energy of ˜0.36 eV was determined, and it also exhibited the lowest ionic conductivity, 0.28 mS cm⁻¹. It can be seen (FIG. 8B) that modifying the composition by replacing some Li₂S with Li₂O results in appreciably enhanced ionic conductivity. The increased ionic conductivities observed for the 2 hr BM Li₂TaS₁₋ₓOₓCl₅ sample, when x is 0.3, 0.6. and 0.9 were 0.8, 3.1, and 3.7 mS cm⁻¹ respectively. An opposite trend was observed for the associated activation energies with the lowest value of 0.32 eV exhibited by Li₂TaS_{0.1}O_{0.9}Cl₅. Oxygen incorporation into the LTSOC structure likely helped stabilize the superionic conducting phase, as the transport property exhibited by Li₂TaS_{0.1}O_{0.9}Cl₅ is over 13 times greater than in the pristine Li₂TaSCl5. The ionic conductivity of the 2-hour ball-milled LTSOC material surpasses most reported for lithium-conducting halides, which typically require energy-intensive solid-state reactions or wet-chemical synthesis methods taking dozens of hours, or days, to synthesize.

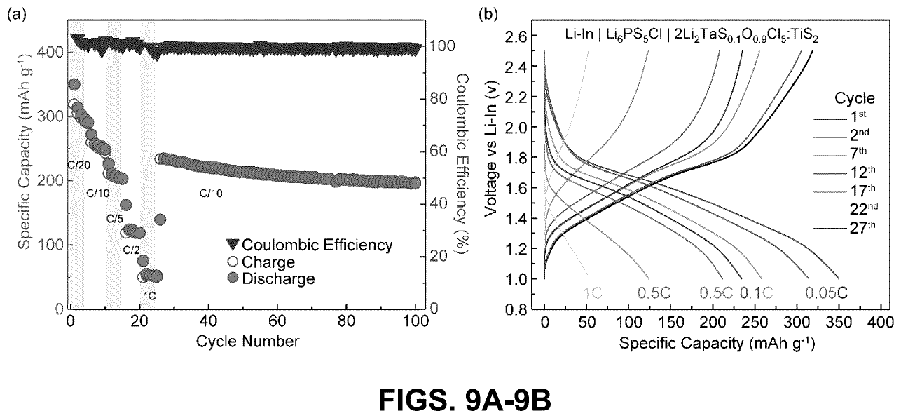

The all-solid-state battery (ASSB) with the set-up TiS₂|LTSOC∥Li₆PS₅Cl∥Li—In was cycled between 1.0V and 2.5V, where the TiS₂ cathode active material (CAM) is electrochemically stable. At a cycling rate of 0.1C, the discharge capacity for the first cycle reached 258 mAh g⁻¹ with a high Coulombic efficiency (CE) of nearly 100% (FIG. 9A). This capacity significantly exceeds the theoretical capacity of the TiS₂ cathode active material (239 mAh g⁻¹). This discrepancy is likely due to potential capacity-generating redox reactions involving unknown phases formed from the interactions between the solid electrolyte and TiS₂, as observed in similar studies on TiS₂ catholytes.⁺ As the current density increased, the capacity decreased from 258 mAh/g (0.1C) to 211 mAh g⁻¹ (0.2C), 124 mAh g⁻¹ (0.5C), and 55 mAh g⁻¹ (1C), demonstrating good capacity retention at higher current densities (FIGS. 9A-9B). After 100 cycles at 0.1C, the capacity retained 196 mAh g⁻¹, corresponding to ˜78% of the initial capacity.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

(1) Wang, Q.; Zhou, Y.; Wang, X.; Guo, H.; Gong, S.; Yao, Z.; Wu, F.; Wang, J.; Ganapathy, S.; Bai, X.; Li, B.; Zhao, C.; Janek, J.; Wagemaker, M. Designing Lithium Halide Solid Electrolytes. Nat Commun 2024, 15 (1), 1050. DOI: 10.1038/s41467-024-45258-3.
(2) Janek, J.; Zeier, W. G. Challenges in Speeding up Solid-State Battery Development. Nature Energy. Nature Research 2023. DOI: 10.1038/s41560-023-01208-9.
(3) Janek, J.; Zeier, W. G. A Solid Future for Battery Development. Nature Energy. Nature Publishing Group Sep. 8, 2016. DOI: 10.1038/nenergy.2016.141.
(4) Liang, J.; Li, X.; Wang, C.; Kim, J. T.; Yang, R.; Wang, J.; Sun, X. Current Status and Future Directions in Environmental Stability of Sulfide Solid-State Electrolytes for All-Solid-State Batteries; 2023.
(5) Duff, B. B.; Elliott, S. J.; Gamon, J.; Daniels, L. M.; Rosseinsky, M. J.; Blanc, F. Toward Understanding of the Li-Ion Migration Pathways in the Lithium Aluminum Sulfides Li3AIS3and Li4.3AlS3.3CI0.7 via 6,7Li Solid-State Nuclear Magnetic Resonance Spectroscopy. Chemistry of Materials 2023, 35 (1), 27-40. DOI: 10.1021/acs.chemmater.2c02101.
(6) Xiao, Y.; Jun, K. J.; Wang, Y.; Miara, L. J.; Tu, Q.; Ceder, G. Lithium Oxide Superionic Conductors Inspired by Garnet and NASICON Structures. Adv Energy Mater 2021, 11 (37). DOI: 10.1002/aenm.202101437.
(7) Zheng, J.; Tang, M.; Hu, Y. Lithium Ion Pathway within Li 7 La 3 Zr 2 O 12-Polyethylene Oxide Composite Electrolytes. Angewandte Chemie 2016, 128 (40), 12726-12730. DOI: 10.1002/ange.201607539.
(8) Ishiguro, Y.; Ueno, K.; Nishimura, S.; lida, G.; Igarashib, Y. TaCI5-Glassified Ultrafast Lithium Ion-Conductive Halide Electrolytes for High-Performance All-Solid-State Lithium Batteries. Chem Lett 2023, 52 (4), 237-241. DOI: 10.1246/cl.220540.
(9) Combs, S. R.; Todd, P. K.; Gorai, P.; Maughan, A. E. Editors' Choice—Review—Designing Defects and Diffusion through Substitutions in Metal Halide Solid Electrolytes. J Electrochem Soc 2022, 169 (4), 040551. DOI: 10.1149/1945-7111/ac5bad.
(10) Kim, K.; Park, D.; Jung, H. G.; Chung, K. Y.; Shim, J. H.; Wood, B. C.; Yu, S. Material Design Strategy for Halide Solid Electrolytes Li3MX6 (X =Cl, Br, and I) for All-Solid-State High-Voltage Li-Ion Batteries. Chemistry of Materials 2021, 33 (10), 3669-3677. DOI: 10.1021/acs.chemmater.1c00555.
(11) Zeier, W. G.; Schlem, R.; Banik, A.; Eckardt, M.; Zobel, M. Na3-xEr1-xZrxC16-A Halide-Based Fast Sodium-lon Conductor with Vacancy-Driven lonic Transport. ACS Appl Energy Mater 2020, 3 (10), 10164-10173. DOI: 10.1021/acsaem.0c01870.
(12) Maughan, A. E.; Ha, Y.; Pekarek, R. T.; Schulze, M. C. Lowering the Activation Barriers for Lithium-Ion Conductivity through Orientational Disorder in the Cyanide Argyrodite Li6PS5CN. Chemistry of Materials 2021, 33 (13), 5127-5136. DOI: 10.1021/acs.chemmater.1c01170.
(13) Lunghammer, S.; Ma, Q.; Rettenwander, D.; Hanzu, I.; Tietz, F.; Wilkening, H. M. R. Bulk and Grain-Boundary Ionic Conductivity in Sodium Zirconophosphosilicate Na3Zr2 (SiO4) 2PO4 (NASICON). Chem Phys Lett 2018, 701, 147-150. DOI: 10.1016/j.cplett.2018.04.037.
(14) Zhang, S.; Zhao, F.; Chen, J.; Fu, J.; Luo, J.; Alahakoon, S. H.; Chang, L. Y.; Feng, R.; Shakouri, M.; Liang, J.; Zhao, Y.; Li, X.; He, L.; Huang, Y.; Sham, T. K.; Sun, X. A Family of Oxychloride Amorphous Solid Electrolytes for Long-Cycling All-Solid-State Lithium Batteries. Nat Commun 2023, 14 (1). DOI: 10.1038/s41467-023-39197-8.
(15) Shi, X.; Zeng, Z.; Sun, M.; Huang, B.; Zhang, H.; Luo, W.; Huang, Y.; Du, Y.; Yan, C. Fast Li-lon Conductor of Li3HoBr6for Stable All-Solid-State Lithium-Sulfur Battery. Nano Lett 2021, 21 (21), 9325-9331. DOI: 10.1021/acs.nanolett.1c03573.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A compound having the formula A_{z}NᵥS_{1-y}O_{y}X₅, wherein
A is Li, Na, K, or any combination thereof;
N is Ta, Nb, or any combination thereof;
X is Cl, Br, I, or any combination thereof;
z is greater than zero to about 2;
y is greater than or equal to zero to less than 1; and
the sum (z+5v) is equal to 7.

2. The compound of claim 1, wherein A is Li or Na.

3. The compound of claim 1, wherein z is about 1.0 to about 2.0.

4. The compound of claim 1, wherein N is Ta.

5. The compound of claim 1, wherein v is about 1.00 to about 1.50.

6. The compound of claim 1, wherein y is from about 0.01 to about 0.99.

7. The compound of claim 1, wherein X is Cl or Br.

8. The compound of claim 1, wherein the compound is Li₂TaS_{1-y}O_{y}Cl₅.

9. The compound of claim 8, wherein y is from about 0.10 to about 0.99.

10. The compound of claim 1, wherein the compound is Li₂TaS_{0.1}O_{0.9}Cl₅, Li₂TaS_{0.4}O_{0.6}Cl₅, or Li₂TaS_{0.7}O_{0.3}Cl₅.

11. The compound of claim 1, wherein the compound has an ionic conductivity of at least about 1.00 mS/cm to about 10.00 mS/cm.

12. The compound of claim 1, wherein the compound has an electronic conductivity of about 1.00×10⁻⁸ S/cm to about 1.00×10⁻¹⁰ S/cm.

13. The compound of claim 1, wherein the compound exhibits superionic conductivity over a temperature range of about 0° C. to about 80° C.

14. The compound of claim 1, wherein the compound has an activation energy for ion transport of from about 0.1 eV to about 0.5 eV.

15. A method for making a compound having the formula A_{z}NᵥS_{1-y}O_{y}X₅, wherein
A is Li, Na, K, or any combination thereof;
N is Ta, Nb, or any combination thereof;
X is Cl, Br, I, or any combination thereof;
1 z is greater than zero to about 2;
y is greater than or equal to zero to less than 1; and
the sum (z+5v) is equal to 7;
the method comprising:
(a) combining in the solid state the following components: (i) A₂S, selected from the group consisting of Li₂S, Na₂S, K₂S, and any combination thereof; (ii) A₂O, selected from the group consisting of Li₂O, Na₂O, K₂O, and any combination thereof; and (iii) NX₅, selected from the group consisting of TaCl₅, TaBr₅, Tal₅, NbCl₅, NbBr₅, Nbl₅, and any combination thereof, to produce a precursor mixture; and
(b) mixing the precursor mixture by mechanochemical milling.

16. The method of claim 15, wherein precursor mixture is mixed by mechanochemical milling for about 1 hour to about 4 hours, wherein the components are substantially anhydrous and mixed in an inert atmosphere.

17. The method of claim 15, wherein the components are combined in stoichiometric amounts.

18. A compound produced by the method of claim 15.

19. A battery comprising the compound of claim 1.

20. A sensor for ion detection, comprising the compound of claim 1.
